(19) United States
(12) Patent Application Publication
(10) Pub. No.: US 2026/0336017 A1
(43) Pub. Date: Oct. 29, 2026

(54) SLITTING METHOD AND HARDWARE FOR COATED FLEXIBLE SUBSTRATES

(71) Applicant: Applied Materials, Inc., Santa Clara, CA (US)

(72) Inventors: Jean Delmas, Santa Clara, CA (US); Leonid Michael Treyger, Santa Clara, CA (US)

(21) Appl. No.: 19/124,326

(22) PCT Filed: Oct. 26, 2023
(86) PCT No.: PCT/US2023/035943

§ 371 Date: Apr. 25, 2025

Related U.S. Application Data
(60) Provisional application No. 63/381,361, filed on Oct. 28, 2022.

(51) Int. Cl. B23K 26/00; B23K 26/0622; B23K 26/082; B23K 26/36; B23K 101/34; B23K 101/36; B26D 1/02

(52) U.S. Cl. CPC B23K 26/0093; B23K 26/0622; B23K 26/082; B23K 26/36; B26D 1/025; B23K 2101/34; B23K 2101/36

(57) ABSTRACT

A method and system for slitting a lithium-coated polyethylene terephthalate (PET) roll is provided. The roll undergoes laser ablation to remove a portion of a layer of lithium where a slit is desired exposing the PET substrate underneath. The roll then undergoes a blade cutting process wherein the roll is cut along exposed PET substrate, producing a plurality of slit rolls. The laser ablation of the roll prior to blade cutting allows lithium to be removed, preventing lithium build-up on the blade. This reduces maintenance time, improves the quality of the slit roll edges, and allows for longer lengths of rolls to be cut. The laser ablation also allows for rolls with thick layers of lithium to be blade cut.

### BACKGROUND

### Field

Embodiments of the present invention generally relate to a laser ablation-based slitting method and apparatus for lithium thin films for energy storage devices

### Description of the Related Art

Rechargeable electrochemical storage systems are increasing in importance for many fields of everyday life. High-capacity energy storage devices, such as lithium-ion (Li-ion) batteries and capacitors, are used in a growing number of applications, including portable electronics, medical, transportation, grid-connected large energy storage, renewable energy storage, and uninterruptible power supply (UPS). In each of these applications, the charge/discharge time and capacity of energy storage devices are fundamental parameters. In addition, the size, weight, and/or cost of such energy storage devices are also fundamental parameters. Further, low internal resistance is integral for high performance. The lower the resistance, the less restriction the energy storage device encounters in delivering electrical energy. For example, in the case of a battery, internal resistance affects performance by reducing the total amount of useful energy stored by the battery as well as the ability of the battery to deliver high current.

One method for manufacturing energy storage devices is roll-to-roll processing. An effective roll-to-roll deposition process not only provides a high deposition rate, but also provides a film surface, which lacks small-scale roughness, contains minimal defects, and is flat, for example, lacks large scale topography. In addition, an effective roll-to-roll deposition process also provides consistent deposition results or “repeatability.”

Thin film lithium energy storage devices typically employ a pre-lithiation process where a thin film of lithium deposited on or over a substrate or web before being laminated with an anode. The roll-to-roll process for pre-lithiation often requires a certain roll width to be economical, even if the desired lithium-coated roll width is smaller. Typically, the lithium-coated roll or stack would be slit or cut with a fixed or rotary blade. The blade, however, tends to build up with lithium decreasing the quality of the cut and increasing maintenance time as the blade needs to be replaced. Further, only a short length of the stack may be cut due to the lithium build-up on the blade.

Therefore, there is a need for an improved apparatus and methods for slitting of lithium thin films for energy storage devices.

### SUMMARY

Embodiments described herein generally relate to a combination laser ablation and blade slitting of lithium thin films for energy storage devices.

In one embodiment, a system for slitting a flexible layer stack is provided. In this embodiment, the system includes a laser source configured to generate a laser beam, an optical scanner, and a blade assembly positioned downstream of the laser beam. Here, the optical scanner is configured to direct the laser beam to the flexible layer stack.

In another embodiment, a slitting apparatus is provided. In this embodiment, the slitting apparatus includes a laser unit and a blade positioned downstream of the laser unit. Here, the laser unit includes an optical assembly, a laser source coupled to the optical assembly, an optical bench positioned opposite the optical assembly, and a controller coupled to the optical assembly.

In yet another embodiment, a method of slitting a coated substrate is provided. In this embodiment, the method includes feeding a coated substrate comprising of at least one coating layer and a substrate layer to a laser unit, exposing a blade cutting area on the coated substrate by removing a section of the at least one coating layer from the substrate layer of the coated substrate, subsequently feeding the coated substrate to a blade assembly, and slitting the coated substrate using the blade assembly within the blade cutting area. Here, the laser unit includes an optical assembly, a laser source coupled to the optical assembly, an optical bench positioned opposite the optical assembly, and a controller coupled to the optical assembly.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 illustrates a schematic diagram of an exemplary laser and blade system according to one or more embodiments of the present disclosure

FIG. 2 illustrates a top plan view of a flexible layer stack according to one or more embodiments of the present disclosure.

FIGS. 3A-3C illustrates a cross-sectional side view of the flexible layer stack of FIG. 2 according to one or more embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

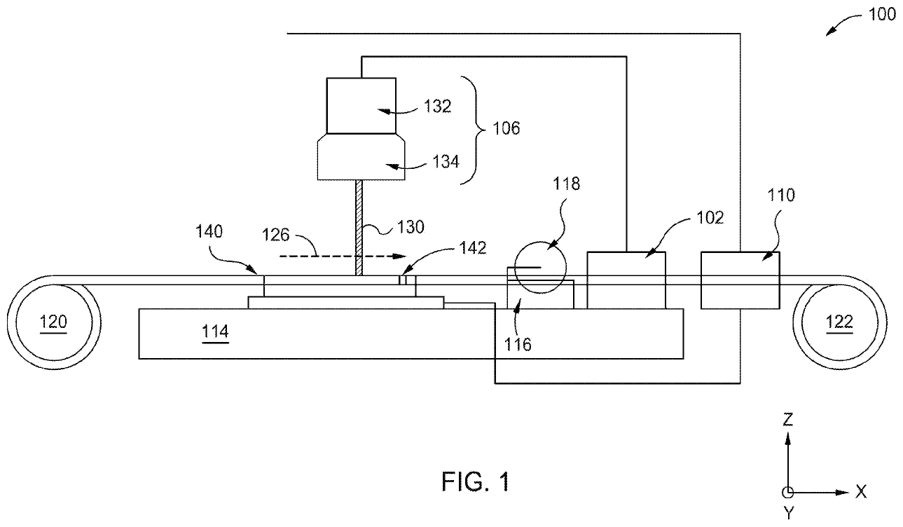

The following disclosure describes combination laser ablation and blade slitting in roll-to-roll deposition systems and methods for performing the same. Certain details are set forth in the following description and in FIGS. 1-3C to provide a thorough understanding of various embodiments of the disclosure. Other details describing well-known structures and systems often associated with mechanical cutting, laser-ablation, web coating, electrochemical cells, and secondary batteries are not set forth in the following disclosure to avoid unnecessarily obscuring the description of the various embodiments.

Many of the details, dimensions, angles and other features shown in the Figures are merely illustrative of particular embodiments. Accordingly, other embodiments can have other details, components, dimensions, angles and features without departing from the spirit or scope of the present disclosure. In addition, further embodiments of the disclosure can be practiced without several of the details described below.

Embodiments described herein will be described below in reference to a roll-to-roll coating system. The apparatus description described herein is illustrative and should not be construed or interpreted as limiting the scope of the embodiments described herein. It should also be understood that although described as a roll-to-roll process, the embodiments described herein can be performed on discrete substrates.

It is noted that while the particular substrate on which some embodiments described herein can be practiced is not limited, it is particularly beneficial to practice the embodiments on flexible substrates, including for example, web-based substrates, panels and discrete sheets. The substrate can also be in the form of a foil, a film, or a thin plate.

It is also noted here that a flexible substrate or web as used within the embodiments described herein can typically be characterized in that it is bendable. The term “web” can be synonymously used to the term “strip,” the term “flexible substrate,” or the term “flexible conductive substrate.” For example, the web as described in embodiments herein can be a foil.

It is further noted that in some embodiments where the substrate is a vertically oriented substrate, the vertically oriented substrate can be angled relative to a vertical plane. For example, in some embodiments, the substrate can be angled from between about 1 degree to about 20 degrees from the vertical plane. In some embodiments where the substrate is a horizontally oriented substrate, the horizontally oriented substrate can be angled relative to a horizontal plane. For example, in some embodiments, the substrate can be angled from between about 1 degree to about 20 degrees from the horizontal plane. As used herein, the term “vertical” is defined as a major surface or deposition surface of the flexible conductive substrate being perpendicular relative to the horizon. As used herein, the term “horizontal” is defined as a major surface or deposition surface of the flexible conductive substrate being parallel relative to the horizon.

It is further noted that in the present disclosure, a “roll” or a “roller” can be understood as a device, which provides a surface, with which a substrate (or a part of a substrate) can be in contact during the presence of the substrate in the processing system. At least a part of the “roll” or “roller” as referred to herein can include a circular-like shape for contacting the substrate to be processed or already processed. In some embodiments, the “roll” or “roller” can have a cylindrical or substantially cylindrical shape. The substantially cylindrical shape can be formed about a straight longitudinal axis or can be formed about a bent longitudinal axis. According to some embodiments, the “roll” or “roller” as described herein can be adapted for being in contact with a flexible substrate. For example, a “roll” or “roller” as referred to herein can be a guiding roller adapted to guide a substrate while the substrate is processed (such as during a deposition process) or while the substrate is present in a processing system; a spreader roller adapted for providing a defined tension for the substrate to be coated or patterned; a deflecting roller for deflecting the substrate according to a defined travelling path; a processing roller for supporting the substrate during processing, such as a process drum, e.g. a coating roller or a coating drum; an adjusting roller, a supply roll, a take-up roll or the like. The “roll” or “roller” as described herein can comprise a metal. In one embodiment, the surface of the roller device, which is to be in contact with the substrate can be adapted for the respective substrate to be coated.

Fabrication of thin film lithium batteries typically employs pre-lithiation process where a thin film of lithium is deposited on or over a substrate or web on a roll. Once the substrate is coated with lithium, the stack often needs to be slit into narrower rolls. The original or source roll of lithium-coated substrate is typically slit using a stationary or rotary blade. As the roll passes through the blade, however, lithium from the coating often adheres to the surface of the blade causing damage to the blade, increased maintenance time, and low-quality edges while only allowing a short length of the source roll to be slit.

Embodiments of the present disclosure which can be combined with other embodiments include a system having a laser unit to remove a portion of the lithium coating ahead of the blade. The laser unit in conjunction with the blade system allows a longer length of the source roll to be slit, produces higher-quality edges on the slit rolls, reduces maintenance time, and allows rolls with thick layers of lithium to be slit.

FIG. 1 illustrates a schematic diagram of an exemplary cutting system 100 that can be utilized to form desired cuts in a flexible layer stack 140, such as a thin film lithium energy storage device. The cutting system 100 is configured to accurately ablate lithium films and cut underlying substrates to produce slit rolls 122 from larger source rolls 120. The cutting system 100 generally includes at least one of each of a laser source 102, an optical assembly 106, a blade 118, a blade stage 116, and a controller 110 for controlling the operation of the cutting system 100. For example, although FIG. 1 depicts one optical assembly 106 producing a single beam 130 and a single blade 118, the cutting system 100 may include one or more optical assemblies 106 producing multiple beams 130 and a corresponding number of blades 118 for cutting the flexible layer stack 140 into multiple strips. In certain embodiments, the cutting system 100 further includes an optical bench 114. The cutting system 100 may also include a vacuum source (not shown) and a debris collector (not shown).

Generally, the laser source 102 may be a solid-state laser, such as a diode-pumped solid-state laser having a rod or slab gain medium, configured to generate a continuous or pulsed laser beam 130 to irradiate the flexible layer stack 140 for forming one or more cuts therein. The laser rod or slab may be formed of any suitable laser crystal materials, including neodymium-doped yttrium aluminum garnet (Nd:YAG; Nd:Y3AI5O12), ytterbium-doped YAG (Yb:YAG), neodymium-doped yttrium orthovanadate (Nd:YVO; Nd:YVO4), and alexandrite. In certain embodiments, the laser rod or slab has a face pumping geometry. In certain embodiments, the laser slab has an edge pumping geometry. Other types of lasers can be used such as a fiber laser or a gas laser.

In certain embodiments, the laser source 102 operates at infrared (IR) wavelengths for removing sections of lithium on lithium coated substrates. The laser source 102 may generate a pulsed laser beam 130. In the embodiments described herein, frequency, pulse width, and pulse energy of the laser beam 130 generated by the laser source 102 are tunable (e.g., adjustable) depending on the material being ablated, desired lateral dimensions of the sections being ablated, as well as a depth of the ablations. Additionally, the movement speed of the laser beam 130, number of pulses, and beam profile and focused spot size may be tuned.

In any form, the laser beam 130 produced by the laser source 102 is projected (e.g., transmitted) towards the flexible layer stack 140 via the optical assembly 106. The optical assembly 106 is optically coupled with the laser source 102 and includes any suitable image projection devices for directing the laser beam 130 towards the flexible layer stack 140 for laser ablation. In certain embodiments, the optical assembly 106 includes a scanner 132, such as a single-or multi-axis large angle galvanometer optical scanner (i.e., galvanometer scanner). The term “galvanometer scanner” refers to any device that responds to an electronic signal from the controller 110 to change a projection or reflection angle of the laser beam 130 to sweep the laser beam 130 across the flexible layer stack 140. Scanner 132 may also be a polygon scanner, an electro-optic scanner, an acousto-optic, or a combination thereof. Utilization of the scanner 132 enables ablation of multiple sections of lithium on the flexible layer stack 140 simultaneously, in addition to scanning of the laser beam 130 across a surface of the flexible layer stack 140 without mechanical translation of the flexible layer stack 140 itself. The scanner 132 may further include any suitable features to facilitate ablation of the materials and structures described herein, such as digital servo feedback, low drift, fast dynamic response, and precise calibration capability.

In certain embodiments, the optical assembly 106 further includes one or more scan lenses 134 having a large field of view that encompasses the entirety of the flexible layer stack 140. In certain embodiments, two or more scan lenses 134 may be utilized for laser ablation of different types of materials, each scan lens 134 specific to a wavelength range of the laser source 102. The scan lenses 134 may be telecentric lenses, F-theta lenses, or a combination thereof. During operation, the laser beam 130 projected by the optical assembly 106 is directed towards the flexible layer stack 140 and the optical bench.

In certain embodiments, the blade stage 116 may be coupled to the optical bench 114, positioned such that the flexible layer stack 140 reaches the blade stage 116 after laser ablation from the optical assembly 106. A blade 118 may be coupled to the blade stage 116 configured to cut the flexible layer stack 140 along a desired path. The blade 118 may be a stationary blade, a rotary blade, a reciprocating blade, or other suitable mechanical cutting mechanism.

The controller 110 may include a central processing unit (CPU) (not shown), memory (not shown), and support circuits (or I/O) (not shown). The CPU may be one of any form of computer processors that are used in industrial settings for controlling various processing and hardware (e.g., laser sources, optical assemblies, scanners, stage motors, and other hardware) and monitor the processes (e.g., processing time, stage and/or wafer nest position, and substrate position). The memory (not shown) is connected to the CPU, and may be one or more of readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include conventional cache, power supplies, clock circuits, input/out circuitry, subsystems, and the like. A program (or computer instructions) readable by the controller 110 determines which tasks are performable on the flexible layer stack 140. The program may be software readable by the controller 110 and may include code to monitor and control (e.g., switch between), for example, the laser beam 130 characteristics (frequency, pulse width, and pulse energy) and movement of the stage 112 or scanner 132.

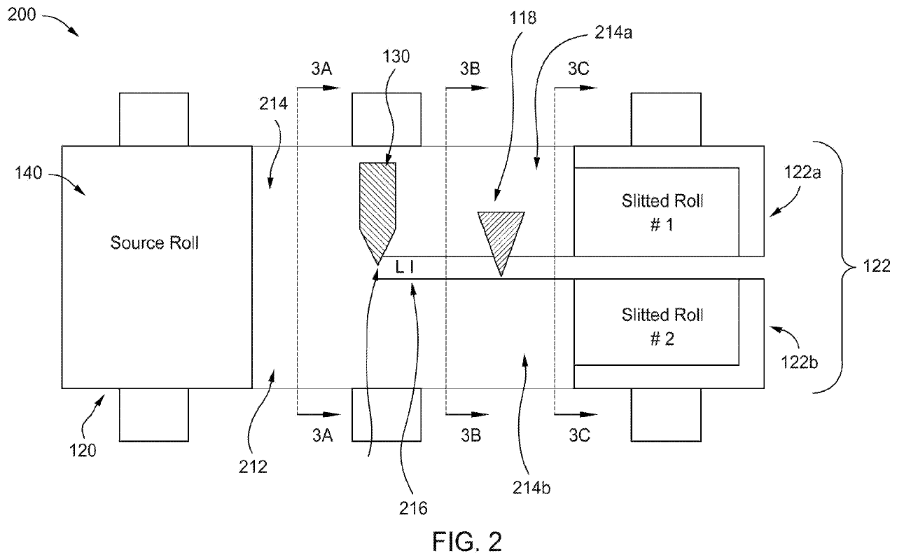

FIG. 2 illustrates a top plan view of a flexible layer stack 210 according to one or more embodiments of the present disclosure. The flexible layer stack 210 can be formed by any suitable deposition process. The flexible layer stack 210 may comprise a flexible substrate 212. The flexible layer stack 210 may also comprise one or more lithium films 214 on a top surface, bottom surface, or both top and bottom surfaces of the flexible substrate 212.

The flexible layer stack 210 shown in FIG. 2 can be, for example, a negative electrode for a secondary cell, such as a negative electrode or anode for a lithium battery. According to some examples described herein, a flexible negative electrode for a lithium battery includes the flexible substrate 212 that can be a current collector including copper and having a thickness of equal to or less than 10 μm, typically equal to or less than 8 μm, beneficially equal to or less than 7 μm, specifically equal to or less than 6 μm, in particular equal to or less than 5 μm. The flexible layer stack 210 further includes a lithium film stack including lithium and having a thickness of equal to or more than 5 μm and/or equal to or less than 15 μm.

In one embodiment, which can be combined with other embodiments, the flexible substrate 212 may be a flexible conductive substrate which comprises, consists of, or consists essentially of a metal, such as copper (Cu) or nickel (Ni). Furthermore, the flexible substrate 212 can include one or more sub-layers. Examples of metals that the current collectors can be comprised of include aluminum (Al), copper (Cu), zinc (Zn), nickel (Ni), cobalt (Co), tin (Sn), silicon (Si), manganese (Mn), magnesium (Mg), alloys thereof, or combinations thereof. In certain embodiments, the web or flexible substrate 212 may be a polymer material. The polymer material can be a resin film selected from a polypropylene film, a polyethylene terephthalate (PET) film, a polyphenylene sulfide (PPS) film, and a polyimide (PI) film. The substrate can be a flexible substrate or web, such as the flexible substrate 212, which can be used in a roll-to-roll coating system.

According to some examples described herein, the flexible substrate 212 can have a thickness equal to or less than about 25 μm, typically equal to or less than 20 μm, specifically equal to or less than 15 μm, and/or typically equal to or greater than 3 μm, specifically equal to or greater than 5 μm. In one example, the flexible substrate 212 has a thickness from about 4.5 μm to about 10 μm. The flexible substrate 212 can be thick enough to provide the intended function and can be thin enough to be flexible. Specifically, the flexible substrate 212 can be as thin as possible so that the flexible substrate 212 can still provide its intended function. The flexible substrate 212 can have a width equal to or less than about 1200 millimeters, for example, from about 100 millimeters to about 1200 millimeters.

According to some examples described herein, the lithium film stack 214 can have a thickness of equal to or less than 20 μm, typically equal to or less than 8 μm, beneficially equal to or less than 7 μm, specifically equal to or less than 6 μm, in particular equal to or less than 5 μm. In one example, the lithium film stack 214 has a thickness from about 1 μm to about 20 μm.

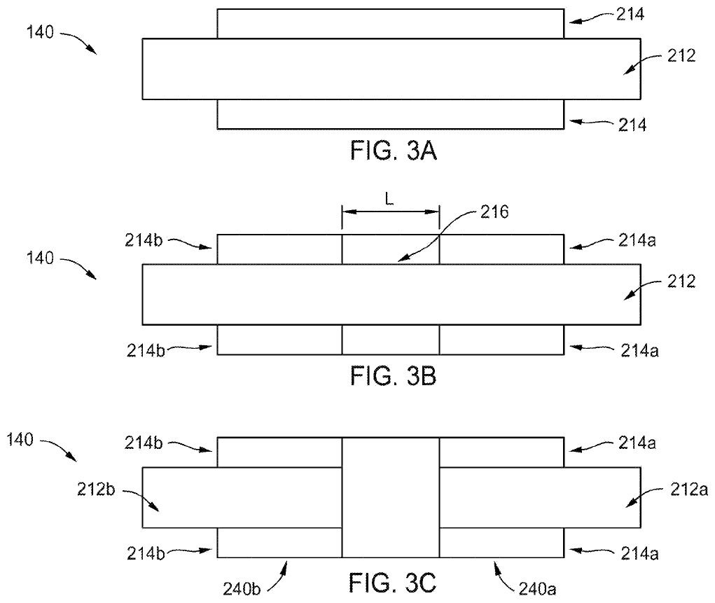

The flexible layer stack 210 can be cut or slit using the combination laser and blade systems and methods described herein. The flexible layer stack 210 can be a lithium metal anode structure, for example, a lithium film formed on a PET substrate. The flexible layer stack 210 can be a lithiated or pre-lithiated anode structure. The flexible layer stack 210 shown in FIGS. 2 and 3A-3C includes the flexible substrate 212 or web having a lithium film or lithium film stack 214 formed thereon. During processing, the flexible substrate 212 is transported in a travel direction shown by arrow 126. In one embodiment, which can be combined with other embodiments, the lithium film or lithium film stack 214 is a lithium metal film. In another embodiment, which can be combined with other embodiments, the lithium film stack 214 includes a lithium metal film and additional films, for example, an anode film such as a graphite film with the lithium metal film formed thereon.

Each lithium film stack 214 includes a lithium film and optionally additional films. Although the lithium film stack 214 in FIG. 2 and FIGS. 3A-3C is shown as a single layer on each side of the flexible substrate 212, it should be understood by those of ordinary skill in the art that the lithium film stack 214 can include a greater or smaller number of layers, which can be provided over, under and/or between the flexible substrate 212 and the lithium metal film 214. Although shown as a double-sided structure, it should be understood by those of ordinary skill in the art that the flexible layer stack 210 can also be a single-sided structure with the flexible substrate 212 and the lithium film stack 214.

The flexible layer stack 140 may be placed on the source roll 120. The flexible layer stack 140 may be fed to the cutting system 100. A laser beam 130 removes a portion of the one or more lithium films 214 from the flexible substrate 212 to produce at least one blade cutting zone 216 of width “L” between two or more segments 214a, 214b of each of the one or more lithium films 214. The at least one blade cutting zone 216 is shown in FIG. 2 as being along a longitudinal centerline of the flexible layer stack 140, but may be located at any desired position on the flexible layer stack 140, such as one-third of the width of the flexible layer stack 140 from an edge of the stack. The width “L” should be greater than a width of blade 118, such as about 5 mm, such as about 3 mm, such as about 1 mm, such as about 0.1 mm. After laser ablation at laser 130, the flexible layer stack 140 undergoes blade cutting at blade 118. The blade 118 may be a stationary blade, a rotary blade, a reciprocating blade, or any suitable mechanical cutting device. The blade 118 cuts the flexible substrate 212 within the at least one blade cutting zone 216. Preferably, the blade 118 cuts the flexible substrate 212 on a centerline of the blade cutting zone 216. The blade cutting produces two or more slit rolls 122 such as a first slit roll 122a and a second slit roll 122b.

FIG. 3A illustrates a cross-sectional side view of the flexible layer stack 140 of FIG. 2 before laser ablation and blade cutting, in accordance with one or more embodiments of the present disclosure. The flexible layer stack 140 in this embodiment comprises two of the one or more lithium films 214 on a top surface and bottom of a flexible substrate 212. Although two lithium film layers are shown in FIG. 3A, other amounts of layers are contemplated, such as one film layer on a top or bottom surface of the flexible substrate.

FIG. 3B illustrates a cross-sectional side view of the flexible layer stack 140 of FIG. 2 after a laser ablation process but before blade cutting process according to one or more embodiments of the present disclosure. As shown in FIG. 3B, a portion of each of the one or more lithium films 214 are removed from the surface of the flexible substrate 212, creating a blade cutting zone 216 in each of the one or more lithium films 214. The blade cutting zone 216 separates a segments 214a from segments 214b by a width “L”.

FIG. 3C illustrates a cross-sectional view of the flexible layer stack 140 of FIG. 2 after laser ablation and blade cutting processes. The blade 118 slits the flexible substrate 212 into two substrate segments 212a and 212b that are rolled into the first slit roll 122a and second slit roll 122b.

Laser parameters selection, such as pulse width, can be integral to developing a successful combination laser and blade cutting process that minimizes damage to the underlying substrate during laser ablation while achieving clean laser scribe cuts. A high frequency nanosecond-pulsed IR laser or picosecond-pulsed IR laser can be used based on laser-material interaction specific to lithium material stacks. Lithium is very unique in that its melting temperature is only 453.65 K (180.50 °C) while the boiling temperature is 1603 K (1330 °C), which is still very high. In comparison, PET has a melting temperature of 523 K (250 °C), and a boiling temperature 623 K (350 °C). The optical properties of lithium are rarely available. For a conductive substrate such as copper, it has a much lower absorption to IR laser than to green (~520-540 ns) or UV laser (<360 nanometer). For example, at ambient temperature, a 1064 nanometer laser has less than 5% optical absorption in copper, while a 532 nanometer Green laser has about 40% optical absorption in copper. The 1064 nanometer laser in a melted copper liquid still has about 5% optical absorption. From the aspect of avoiding copper damage, the 1 μm IR laser wavelength is more advantageous than a Green or UV laser wavelength. In addition, at the same average power level and with the same type of laser, an IR laser is more reliable and cost-effective.

Laser parameters can be selected with benefits and advantages such as providing sufficiently high laser intensity to achieve removal of lithium and to minimize damage to the underlying substrate. Also, parameters can be selected to provide meaningful process throughput for industrial applications with precisely controlled ablation width (e.g., kerf width) and depth. As described above, an ultrashort pulse (USP) laser (e.g., a laser with a pulse duration of, at most, in a femtosecond range) such as a femtosecond or picosecond pulse laser is suitable for providing such advantages.. Such pulse width ranges for UPS may be 5 fs to 999 fs, preferably 10 fs to 999 fs for a femtosecond pulse laser and 1 ps to 10 ps for a picosecond pulse laser. Regarding USPs, a shorter pulse width results in higher peak power and fewer thermal effects. This increases the control over the removal rate. For example, a 10 fs pulse has 1000 times higher peak power than 10 ps pulse of the same pulse energy. Therefore, the wavelength range is of less importance as ablation may be ceased at a precise depth, removing the specific amount or thickness of lithium without thermally damaging the underlying substrate.

However, nanosecond-pulse laser ablation is also suitable, as pulses longer than a few tens of picoseconds will start having more pronounced thermal effects. Nanosecond pulse lasers are also more cost-effective, although certain wavelengths may provide better performance than others. For a PET substrate, a wavelength range of 450 nm to 1600 nm, preferably 450 nm to 1550 nm, will facilitate laser ablation of lithium with nanosecond pulses such that the PET film is highly transparent to light. A wavelength of less than 450 nm, preferably less than 355 nm, will result in scribing or cutting of the PET substrate beyond ablation of an overlying layer of lithium. For a polyimide (PI) substrate, a wavelength range of 700 nm to 1700 nm, preferably 750 nm to 1600 nm, will provide laser ablation of lithium using nanosecond pulses. Similarly, a wavelength of less than 450 nm will scribe or cut the PI substrate beyond ablation of the overlying layer of lithium.

The nanosecond pulses may range between 1 ns to 200 ns, preferably between 1 ns and 50 ns, preferably between 1 ns and 10 ns. For example, in one embodiment, a nanosecond-pulse laser process having a wavelength closer to or in the IR range provides a cleaner ablation process than a nanosecond-pulse laser process having a wavelength closer to or in the UV range. In a specific such embodiment, a femtosecond-pulse laser process suitable for semiconductor wafer or substrate scribing is based on a laser having a wavelength of approximately greater than or equal to one micrometer. In a particular such embodiment, pulses of approximately less than or equal to 15 nanoseconds of the laser having the wavelength of approximately greater than or equal to one micrometer are used. However, in an alternative embodiment, dual laser wavelengths (e.g., a combination of an IR laser and a UV laser) can be used.

In an alternative embodiment, laser ablation by laser beam 130 may not entirely remove lithium from the at least one blade cutting zone 216. Doing so would result in a significantly diminished lithium film 214 at the at least one blade cutting zone 216 and provide the advantages of the present disclosure and prevent damage to the roll surface underneath. In another alternative embodiment, laser ablation by laser beam 130 occurs outside of the roll area or at specific angles of incidence determined by the optical properties of the flexible substrate 212.

Embodiments and all of the functional operations described in this specification can be implemented in digital electronic circuitry, or in computer software, firmware, or hardware, including the structural means disclosed in this specification and structural equivalents thereof, or in combinations of them. Embodiments described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

When introducing elements of the present disclosure or exemplary aspects or embodiment(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to embodiments of the present disclosure, other and further embodiments of the disclosure may be devised without departing from the basic scope thereof, and the scope thereof is determined by the claims that follow.

What is claimed is:

1. A system for slitting a flexible layer stack, comprising:
a laser source configured to generate a laser beam;
an optical scanner; and
a blade assembly positioned downstream of the laser beam.

2. The slitting system of claim 1, wherein the laser source is an infrared laser source.

3. The system of claim 1, wherein the optical scanner is configured to direct the laser beam to the flexible layer stack.

4. The system of claim 1, wherein the laser beam is configured to remove at least one layer of lithium from the flexible layer stack.

5. The system of claim 1, wherein the laser beam is configured to not damage a flexible substrate layer of the flexible layer stack.

6. The system of claim 5, wherein the flexible substrate layer comprises polyethylene terephthalate, polyimide, polyphenylene sulfide, or combinations thereof.

7. The system of claim 5, wherein the flexible substrate layer is a flexible conductive layer comprising copper, nickel, aluminum, zinc, cobalt, tin, silicon, manganese, magnesium, alloys thereof, or combinations thereof.

8. The slitting system of claim 1, wherein the blade assembly comprises a blade and a blade stage.

9. The slitting system of claim 1, wherein the blade assembly comprises a stationary blade.

10. A slitting apparatus comprising:
a laser unit comprising;
an optical assembly;
a laser source coupled to the optical assembly;
an optical bench positioned opposite the optical assembly; and
a controller coupled to the optical assembly; and
a blade positioned downstream of the laser unit.

11. The slitting apparatus of claim 10, wherein the laser source is a solid-state laser configured to produce a continuous laser beam.

12. The slitting apparatus of claim 10, wherein the laser source is a solid-state laser configured to produce a pulsed laser beam.

13. The slitting apparatus of claim 10, wherein the laser source is configured to produce a laser beam capable of ablating a coating of a flexible layer stack.

14. The slitting apparatus of claim 13, wherein the laser source is further configured to not damage a flexible substrate of the flexible layer stack.

15. A method of slitting a coated substrate, comprising:
feeding a coated substrate comprising of at least one coating layer and a substrate layer to a laser unit;
exposing a blade cutting area on the coated substrate by removing a section of the at least one coating layer from the substrate layer of the coated substrate;
subsequently feeding the coated substrate to a blade assembly; and
slitting the coated substrate using the blade assembly within the blade cutting area.

16. The method of claim 15, wherein the laser unit comprises:
an optical assembly;
a laser source coupled to the optical assembly;
an optical bench positioned opposite the optical assembly; and
a controller coupled to the optical assembly.

17. The method of claim 15, wherein the coating layer comprises lithium.

18. The method of claim 15, wherein the substrate layer comprises a flexible substrate further comprising polyethylene terephthalate, polyimide, polyphenylene sulfide, alloys thereof, or combinations thereof.

19. The method of claim 15, wherein the substrate layer comprises a flexible conductive substrate further comprising copper, nickel, aluminum, zinc, cobalt, tin, silicon, manganese, magnesium, alloys thereof, or combinations thereof.

20. The method of claim 15, wherein the blade cutting area is at least one longitudinal section of the coated substrate configured to produce at least two slit coated substrates.
